(19) United States
(12) Patent Application Publication
(10) Pub. No.: US 2015/0339275 A1
(43) Pub. Date: Nov. 26, 2015

(54) RENDERING OF ON-LINE CONTENT

(71) Applicant: Yahoo! Inc., Sunnyvale, CA (US)

(72) Inventors: Benoit Schillings, Los Altos Hills, CA (US); Rick Hawes, Mountain View, CA (US)

(73) Assignee: Yahoo! Inc., Sunnyvale, CA (US)

(21) Appl. No.: 14/282,639

(22) Filed: May 20, 2014

(51) Int. Cl. G06F 17/22; G06F 17/30

(52) U.S. Cl. CPC G06F 17/2247; G06F 17/30353; G06F 17/3089

(57) ABSTRACT

Example methods, apparatuses, and/or articles of manufacture are disclosed that may be implemented, in whole or in part, using one or more computing devices to facilitate and/or support one or more processes and/or operations for rendering of on-line content, such as via a browser, for example.

### BACKGROUND

1. Field

The present disclosure relates generally to processing on-line content, such as, for example, rendering content objects for display.

2. Information

The Internet is widespread. The World Wide Web or simply the Web, provided by the Internet, is growing rapidly, at least in part, from the large amount of content being added seemingly on a daily basis. A wide variety of content in the form of stored signals, such as, web pages, text documents, images, audio files, and/or video files, for example, is continually being processed, such as, identified, located, retrieved, accumulated, stored, and/or communicated, for example. With so much on-line content being available, a number of tools and/or services may be provided to users so as to allow for copious amounts of content to be searched in a more efficient and/or more effective manner. For example, service providers may allow users to search the Web and/or other like networks using various systems, such as content management systems, including search engines, for example. Search engines may, for example, help a user to search the Web from a search query so as to try to locate and/or retrieve content of interest.

In addition to locating and/or retrieving content, such as one or more electronic documents, for example, search engines may present retrieved content, such as to a user, in a suitable manner, such as for display, for example, via an associated computing device that may include display capability. More effective and/or more efficient content presentation may, for example, offer a richer and/or more satisfying experience, such as for a user. Likewise, for users, it may facilitate and/or support information-seeking behavior, increase engagement and/or strengthen loyalty, to provide a few beneficial example. Thus, presentation of content in a more effective and/or more efficient manner continues to be an area of development.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a flow diagram illustrating an implementation, such as for processing on-line content.

FIG. 2 is an example representation of an implementation of a rendering of online content.

FIG. 3 is a schematic diagram illustrating an implementation of a computing environment associated with one or more special purpose computing apparatuses.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, and/or systems that would be known by one of ordinary skill have not been described in detail so as not to obscure claimed subject matter.

Some example methods, apparatuses, and/or articles of manufacture are disclosed herein that may be used, in whole or in part, to facilitate and/or support one or more processes and/or operations, such as for processing of on-line content, which may include, for example rendering, such as in a browser, for example. In this context, “rendering,” “render,” “rendition” and/or similar terms may refer to a process of electronic generation, depiction, representation, communication, and/or conversion of content, such as into a visual form, for example. Typically content that may be accessed electronically and/or on-line is involved. By way of illustration, in some instances, content may, for example, be rendered via a computing device that may include a display capability, such as via generating an image, text, etc. or any combination thereof, for example, from a suitable memory device, such as may contain stored files. For example, a computing device may execute one or more applications and/or features (e.g., a browser, etc.). “On-line” may refer to a type of access that may be implemented via one or more computing and/or communications networks, such as, for example, the Internet, an intranet, a device network, such as a network for peripherals, and/or a computer network. As used herein, “content” may comprise signals, such signal packets, for example, and/or states, such as physical states on a memory device, for example, but, otherwise is employed in a manner irrespective of format, such as any expression, realization, and/or communication, for example. Likewise, content may comprise a representation of any information, knowledge, and/or experience, for example. In this context, electronic or online content refers to content in a form that although not necessarily capable of being perceived by a human, (e.g., via human senses) may nonetheless be transformed into a form capable of being so perceived, such as visually and/or audibly, for example. Examples may include text, audio, images, video, combinations, etc. Thus, these examples of content may be stored and/or transmitted electronically, such as before or after being perceived by human senses. In general, it may be understood that electronic and/or online content may be intended to be referenced in a particular discussion, although in the particular context the term “content” may be employed for ease of discussion. Particular examples of content will be described in greater detail below.

With advances in technology, it has become more typical to employ distributed computing approaches in which a computational problem may be divided among computing devices and/or networking devices, including one or more clients and one or more servers, via a computing and/or communications network.

A network may comprise two or more network devices and/or may couple network devices so that signal communications, such as in the form of signal packets, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets), such as via a wired or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof. Signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and/or similar terms are to be associated with appropriate physical quantities and are intended to merely be convenient labels.

Likewise, in this context, the terms “coupled”, “connected,” and/or similar terms may be used generically. It should be understood that these terms are not intended as synonyms. Rather, “connected” if used generically may be used to indicate that two or more components, for example, are in direct physical and/or electrical contact; while, “coupled” if used generically may mean that two or more components are in direct physical or electrical contact; however, “coupled” if used generically may also mean that two or more components are not in direct contact, but may nonetheless co-operate or interact. The term coupled may also be understood generically to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description and/or usage may provide helpful guidance regarding inferences to be drawn.

A network may also include now known, or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as computing and/or communication protocols (e.g., network protocols, etc.), may interoperate within a larger network. In this context, the term sub-network refers to a portion or part of a network. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link or connection between otherwise separate and/or independent LANs. In this context, a private network refers to a particular, limited set of network devices able to communicate with other network devices in the particular, limited set, such as via signal packet transmissions, for example, without a need for re-routing and/or redirecting such network communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. It is understood in this context that a private network may provide outgoing network communications to devices not in the private network, but such devices outside the private network may not direct inbound network communications to devices included in the private network.

The Internet refers to a decentralized global network of interoperable networks that comply with the Internet Protocol (IP). It is noted that there are several versions of the Internet Protocol. Here, the term Internet Protocol or IP is intended to refer to any version, now known or later developed. The Internet includes local area networks (LANs), wide area networks (WANs), wireless networks, and/or long haul public networks that, for example, may allow signal packets to be communicated between LANs. The term world wide web (WWW) and/or similar terms may also be used, although it refers to a sub-portion of the Internet that complies with the Hypertext Transfer Protocol or HTTP. It is noted that there are several versions of the Hypertext Transfer Protocol. Here, the term Hypertext Transfer Protocol or HTTP is intended to refer to any version, now known or later developed. It is likewise noted that in various places in this document substitution of the term Internet with the term World Wide Web (WWW) may be made without a significant departure in meaning and may, therefore, not be inappropriate in that the statement would remain correct with such a substitution.

Signal packets, also referred to as signal packet transmissions, may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address. Although the Internet comprises a network of interoperable networks, not all of those interoperable networks are necessarily available or accessible to the public.

Although physically connecting a network via a hardware bridge is done, a hardware bridge may not typically include a capability of interoperability via higher levels of a network protocol. A network protocol refers to a set of signaling conventions for computing and/or communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance and/or substantial compatibility.

Typically, a network protocol has several layers. These layers may be referred to here as a network stack. Various types of network transmissions may occur across various layers. For example, as one moves higher in a network stack, additional operations may be available by initiating network transmissions that are compatible and/or compliant with a particular network protocol at these higher layers. Therefore, for example, a hardware bridge may be unable to forward signal packets since it may operate at a layer of a network stack that does not provide that capability. Although higher layers of a network protocol may, for example, affect device permissions, user permissions, etc., a hardware bridge, for example, may typically provide little user control, such as for higher layer operations.

A VPN, such as previously described, may enable a remote device to communicate via a local network, but may also have drawbacks. A router may allow network communications in the form of network transmissions (e.g., signal packets), for example, to occur from a remote device to a VPN server on a local network. A remote device may be authenticated and a VPN server, for example, may create a special route between a local network and the remote device through an intervening router. However, a route may be generated and/or also regenerate if the remote device is power cycled, for example. Also, a VPN typically may affect a single remote device, for example, in some situations.

A network, such as the Internet, as one example, may be very large, such as comprising thousands of nodes, millions of nodes, billions of nodes, or more, as examples. As was indicated, in an embodiment, one or more processes and/or operations for rendering of on-line content may be used, at least in part, in connection with content management systems, which may include, for example, a search engine. Typically, a search engine may comprise, for example, a content retrieval computing platform (e.g., computing device) that may be employed at least in part to locate and/or retrieve on-line content, such as one or more web documents. As used herein, the terms “web document,” “electronic document,” and/or “document” may be used interchangeably and may refer to a collection of digital signals, such as communicated and/or stored signals (e.g., physical memory states), for example, representing any content including, as examples, source code, text, image, audio, video file, and/or the like. Web documents include content and may, for example, be processed by a special purpose computing device, although processing of content may not necessarily take place in a form in which it is intended that the content be capable of being easily perceived by human senses during processing; however, for example, after processing, content of a web document, for example, may be played and/or displayed to or by a user and/or client, such as a client device, so that it is capable of being perceived by human senses. In general, typically reference to a user in this context is referring to a user in connection with use of a device, such as via use of a client device and/or other similar network and/or computing device. In an embodiment, web documents may include one or more embedded references and/or hyperlinks to images, audio and/or video files, and/or other web documents. For example, one common type of reference may comprise a Uniform Resource Locator (URL). As a way of illustration, web documents may include a web page, news feed, rating and/or review post, question, answer, status update, portal, blog, e-mail, text message, hyperlink, Extensible Markup Language (XML) document, media file, web page pointed and/or referred to by a URL, etc., just to name a few examples.

A search engine may further arrange and/or present retrieved content and/or content capable of being retrieved in a variety of formats, such as, for example, via a computing and/or network device associated with a user. For example, a search engine may arrange web documents in a visually ascending or descending order of relevance in a listing of returned search results. In some instances, a listing of returned search results may, for example, be presented in the form of one or more links (e.g., hyperlinks) to relevant content. From a listing of returned search results, a user may download a web page, such as by clicking on a corresponding link within the listing, for example. In this context, “download,” “downloading,” “loading,” and/or like terms may be used interchangeably and may refer to a process of electronically transferring and/or offering to transfer (e.g., ‘pushing’ and/or ‘pulling’) content, such as in the form of a collection of digital signals (e.g., binary digital signals stored as physical memory states), representing one or more stored files, for example, from a resource, such as a memory, a network device, and/or a computing device, to another resource, such as a memory, a network device and/or a computing device. For example, a user may download content from a network server to a client device, from a hard disk drive to a local memory, etc., such as by clicking on an appropriate link, activating an appropriate command, and/or the like. Typically, but not necessarily, loading or downloading is used in reference to a locally accessible memory of a computing and/or network device.

In some instances, content may, for example, be downloaded without user interaction. In this context, user interaction refers to any mechanism for a user to interact with a device, such as a computing and/or network device, including by clicking, touching, rolling, actuating, using voice commands, etc. For example, content may be downloaded via a client-side script, such as a JavaScript®-type script as a result of launching of a browser, just to illustrate one possible implementation. Claimed subject matter is not so limited, of course. In an embodiment, content may, for example, be downloaded via one or more client-server communications, on-demand, via push and/or pull technology, and/or the like. As used herein, “browser,” “web browser,” “rendering browser” and/or similar terms may be used interchangeably and may refer to an application and/or feature that may be used, at least in part, to load, execute and/or render content capable of being accessed, such as retrieved, via a computing and/or communications network. A browser may, for example, load, execute and/or render content via accessing, retrieving, presenting, traversing, etc. content and/or like resources available via the Web, such as in connection with a suitable content management system, such as a search engine, for example.

In an embodiment, a browser may render content, such as a web page, for example, using HyperText Transfer Protocol (HTTP), specifying how content may be formatted, transmitted, requested, displayed, processed, and/or the like. In some instances, a browser may, for example, be utilized, at least in part, to access, retrieve, present, traverse, etc. content and/or like resources associated with a private network, public network, electronically stored files in a file system, distributed or otherwise, and/or the like, including any combination thereof. Browsers, such as web browsers, are generally known and need not be described here in greater detail. However, it is noted that loading content, such as downloading, as previously described, may take place without content necessarily being executed or being rendered. Likewise, content may be executed, such as execution of software instructions by a local processor, without content necessarily being rendered (e.g., without content necessarily being generated for display).

In some instances, a collection of digital signals representing stored files, such as electronically stored in memory, for example, may be processed in a suitable manner so as to render applicable content for user consumption (e.g., viewing, listening, etc.), interaction (e.g., clicking, scrolling, etc.), and/or the like. For example, stored memory states in the form of stored files, such as electronically stored in memory, for example, may be transformed into digital and/or analog signals that may be used, at least in part, to visually display and/or audibly reproduce content. As one simple, non-limiting, example, electronically stored content, for example, may be loaded and rendered for display via a computing device so that a user is able to perceive the content visually.

As will be seen, in some instances, a document (e.g., stored content), such as a displayable web page, for example, may comprise a plurality of portions associated with various types of content capable of being visually arranged on a display after being rendered, such as in accordance with a designed or otherwise suitable page format. As a way of illustration, portions associated with various types of content may comprise, for example, editorial content (e.g., articles, etc.), digital publications (e.g., magazines, etc.), static and/or animated images, selectable links, branding-related content, copyright-related content, other textual and/or non-textual content, or any combinations thereof. In an embodiment, one or more portions of content may include, for example, an advertisement and/or other suitable promotional content (e.g., a coupon, special offer, etc.). Of course, these are merely illustrative particulars relating to content, and claimed subject matter is not limited to illustrations.

As was indicated, content may, for example, be visually arranged on a display, such as a display for a computing device and/or a special purpose computing platform, for example. A special purpose computing platform may comprise, for example, any suitable computing and/or network device, such as a client device, a mobile device, a stationary device, or any combination thereof. A mobile device may comprise, for example, a client device that may from time to time have a position and/or location that may change. A stationary device may comprise, for example, a client device and/or a server device that may have a position and/or location that typically, although not necessarily, does not change substantially within a period of time.

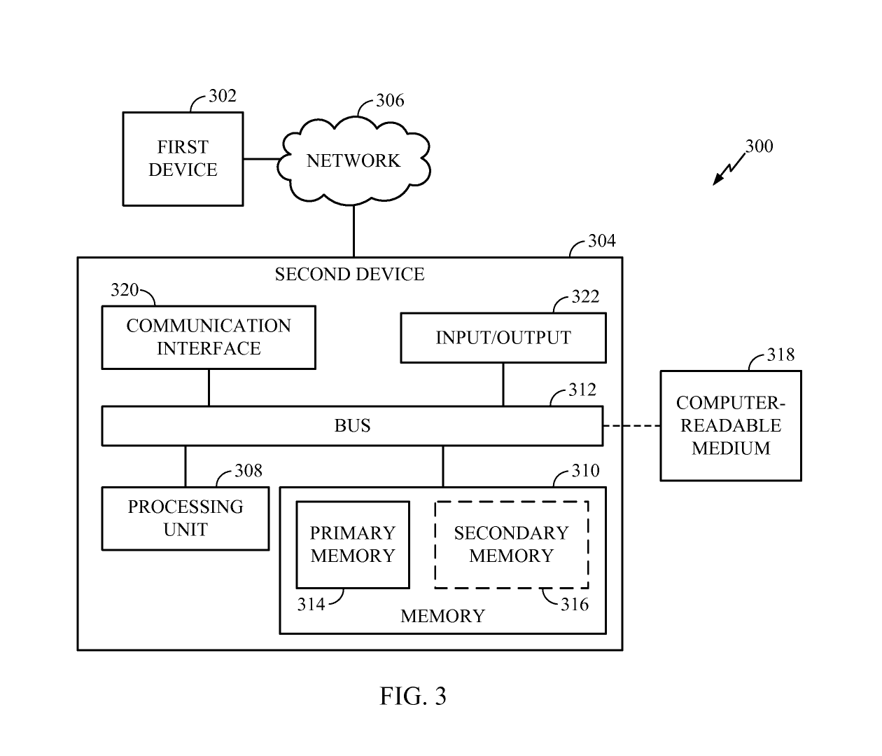

By way of illustration, devices may include, for example, cellular telephones, satellite telephones, smart telephones, voice over internet protocol (VoIP) or IP telephones, desktop computers, personal digital assistants (PDAs), laptop computers, personal entertainment systems, tablet personal computers (PC), personal audio and/or video devices, personal navigation devices, e-book readers, and/or the like. Claimed subject matter is not limited, of course, to these examples provided merely as a few illustrations. For example, in some instances, as suggested, a special purpose computing platform may comprise a device serving in an embodiment as both a server device and a client device. An example of a special purpose computing platform (e.g., device) that may be used, at least in part, to facilitate and/or support one or more processes and/or operations for rendering of on-line content will be described in greater detail below with reference to FIG. 3.

As alluded to previously, delay for a user, for example, may result in a less than satisfying experience. Thus, reducing the amount time to render content capable of being perceived, such as for user consumption, interaction, etc., may be desirable. It may, for example, offer faster browsing experience, promote user engagement, strengthen user loyalty, increase conversion rates, search engine ranking, and/or the like, although claimed subject matter is not limited in scope in this respect. In this context, “acceptably perceivable” refers to a state and/or level of rendering, such as may be characterized by a particular and/or specified set of criteria, as further discussed and illustrated by examples below. In general, it refers to achieving a sufficient quality of rendering of content so that the being rendered content is able to be perceived in a manner that is adequately satisfying. For example, a web page, or portions thereof, for example, may achieve such a level if, despite not yet being fully rendered, a set of content is rendered adequately for user consumption (e.g., viewing, listening, etc.), interaction (e.g., clicking, scrolling, etc.), and/or the like.

In some instances, an acceptably perceivable may include, for example, a particular amount of content associated with a plurality of portions of content being rendered via a browser. For example, in one embodiment, this might comprise visually static and/or non-functional content. In another embodiment, this may also comprise functioning hyperlinks, but no additional functionality. As another example, an amount of content may comprise, for example, content tailored for a particular portion of a display, screen resolution, type of a client device, and/or the like. Claimed subject matter is not limited to illustrative examples, of course. However, continuing, as will be seen, content, such as a web document, may be at an acceptable perceivable level if the content that is rendered is not dependent content, meaning, in this context, that rendering the particular content does not depend on loading, executing and/or rendering of other content before the particular content is rendered, as discussed in more detail below.

An “object,” as used herein, may refer to a divisible portion or sub-portion of content that may be loaded, executed, and/or rendered so as to facilitate and/or support rendering of a larger set of content. It may be convenient at times to think of such content as falling into a content class, such as a bit map, computer instructions, text, etc. In some instances, an object may be referenced via a suitable identifier. For example, a stored file comprising content, and in some cases one or more associated “read” and/or “write” routines or modes for manipulating, may comprise an object, just to illustrate possible implementations. At times, an object may comprise, for example, a JavaScript®-type object, content element that may be required and/or useful, such as for rendering of a web document (e.g., a web page, etc.), or the like. Objects are also known and need not be described here in greater detail.

Documents to be rendered, for example, such as more complex web pages, may comprise a larger amount and/or various types of content that may be associated with a plurality of portions of divisible content, as discussed above. In some instances, this may present a number of challenges. For example, at times, a larger amount of content may not be capable of loading in parallel, such as due to multiple HTTP requests, for example, and, as such, rendering of an overall document comprising the overall content, for example may be delayed. In addition to browser load-type delays, certain type of content (e.g., a background image, text, etc.) may, for example, wait for another type of content (e.g., a foreground image, text, etc.) to finish loading, executing, and/or rendering, before starting to be loaded, executed and/or rendered, which may also increase a rendering time overall. As indicated previously, this is referred to in this context as dependent content.

Thus, in some situations, certain content may be dependent, at least in part, on other content, for example, which may interrupt or have the potential to adversely affect in some manner loading, execution and/or rendering. For example, certain content may reference several stored files including importing content from other content, loading scripts from other scripts, accessing libraries, design elements, etc., which may result in delay, such as a browser responding and/or operating more slowly.

It may be useful to track and/or uncover these or like dependencies, such as to improve and/or affect timeliness of content rendering, for example. In some instances, tracking one or more dependencies, assessing order of loading, execution and/or rendering and/or like tasks may, for example, make more evident possibilities to improve timeliness of rendering. However, often, such tracking may be performed manually. Manually performing a tracking task as described, however, may be time-consuming, labor-intensive, etc. Accordingly, it may be desirable to develop one or more methods, systems, and/or apparatuses that may facilitate and/or support rendering of content in a more effective and/or more efficient manner, for example.

As another example, at times, addressing content rendering may be particularly useful for client devices with limited computing and/or power resources, such as battery-operated mobile devices. For example, longer downloads and/or a larger amount of content may, tax available bandwidth in wireless communication links, memory of a mobile device, and/or the like. In some instances, this may, for example, increase power consumption of mobile devices, affect their operating lifetime and/or overall utility, increase cellular network costs for a user, etc. Of course, these are merely examples and claimed subject matter is not limited in scope to illustrative examples, such as these.

Thus, as will be described in greater detail below, in an embodiment, a customization tool may be provided, such as for use in connection with a suitable web browser, for example, that may improve timeliness of content rendering. For example, content for a document, such as a web page, for example, may be rendered to an acceptably perceivable level, such as by referencing a plurality of objects that are part of the content of the document. The plurality of objects, in an embodiment, may be referenced in a manner to reduce delay attributable to dependencies in rendering the content objects. In this context, referencing an object refers to loading, executing and/or rendering an object. Thus, as a non-limiting example, among a plurality of objects, content comprising the objects may be rendered by referencing the objects so that objects are loaded, executed and/or rendered in a manner to reduce delay to generating content of the document to a level in which the content is acceptably perceivable to a user.

For example, in an embodiment, a tool may facilitate and/or support tracking of content objects that are loaded, executed and/or rendered as part of rendering the content of a document. In some instances, for example, if a content object is loaded but not used immediately during typical rendering of a document, for example, loading, for example, may be deferred as part of rendering content to an acceptably perceivable level. In this context, “defer,” “deferral,” “deferring,” and/or like terms may refer to delaying and/or suspending loading, executing and/or rendering, for example, until some future time, if at all. As such, in an embodiment, for example, a tool may, for example, add instrumentation to a browser-related process of content rendering so that tracking of loading, execution and/or rendering of objects that together comprise the content of a document is capable of occurring.

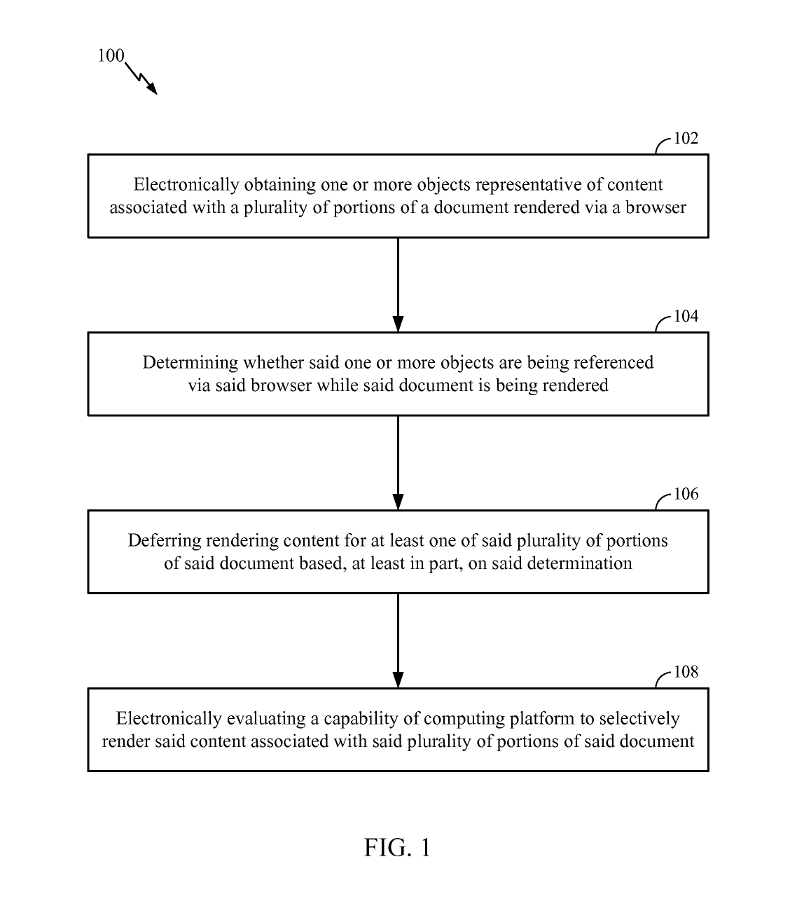

With this in mind, attention is now drawn to FIG. 1, which is a flow diagram illustrating an implementation of an example process 100, such as may be performed, in whole or in part, using, as an example, one or more special purpose computing platforms. Content associated with example process 100 may be represented via a set of digital signals and/or memory states, for example. Operations may be illustrated and/or described concurrently and/or with respect to a certain sequence, other sequences and/or concurrent operations; however, these are examples and are not intended to limit claimed subject matter. In addition, although the description below references particular aspects and/or features illustrated, one or more operations may be performed with other aspects and/or features, such as instead or in addition.

Example process 100 may, for example, begin at operation 102, with electronically obtaining one or more objects representative of content associated with a plurality of portions of a document, such as may be rendered via a browser, such as a web browser, for example. For example, a log file may track loading, execution and/or rendering of one or more content objects, such as while a web document is being rendered, for example. As was indicated, in an embodiment, operations such as these, for example, may be facilitated and/or supported by a suitable client-side script, such as a JavaScript®-type script, for example, upon and/or after launching of a browser, though claimed subject matter is not so limited. In some instances, one or more objects may, for example, be time-stamped (e.g., digitally, etc.) so as to record a time at which a particular event occurred. In an embodiment, one or more objects may be annotated in a suitable manner, such as via a readable human description, for example, so as to identify objects loaded, executed and/or rendered, as described. As such, a timeline-type view of rendering of particular content (e.g., objects), such as associated with a web document may, for example, be obtained.

At operation 104, it may be determined whether one or more objects are being referenced via a browser (e.g., in connection with a client-side script, etc.), such as while a web document is being rendered, for example. In this context, “referencing” used in connection with rendering of a content object refers to loading, executing and/or rendering of the object. As a way of illustration, in an embodiment, one or more objects (e.g., in a “read,” “write,” etc. mode) may, for example, be referenced by a JavaScript®-type script in connection with a Document Object Model (DOM) library, though claimed subject matter is not so limited. Thus, in some instances, it may, for example, be determined if and/or when a particular object has been referenced (e.g., referred into DOM trees, etc.), such as via a browser. Likewise, in an embodiment, one or more referenced objects may, for example, be time-stamped to record a time at which a particular referencing event occurred. Depending at least in part on an implementation, one or more referenced objects may, for example, be added to a log file, such as discussed above, or, optionally or alternatively, a separate log file may be generated. In an embodiment, one or more referenced objects may be annotated in a similar fashion, such as via a readable human description, for example, so as to identify objects representing referenced content. Thus, similarly, a timeline-type view of referencing of particular content, such as associated with a plurality of portions of a document (e.g., objects) may, for example, be obtained.

In some instances, based, at least in part, on one or more referenced objects, one or more objects that have been loaded but not used at a given time, such as via a browser, for example, may be identified via a suitable log file, in an embodiment, for example. These one or more objects may also be annotated in a suitable manner, such as via a readable human description, for example. Thus, for an embodiment, as an example, a description may identify content that may not necessarily be useful or desirable, such as for a document, or content of the document, to be omitted if rendering to a level acceptably perceivable to a user, for example. To illustrate, if a client-side script (e.g., JavaScript®, etc.) and/or a portion thereof performs a computation that is not being referenced until and/or after a web document has been fully rendered, it may, for example, be determined and/or inferred that a corresponding object may be omitted, at least for rendering an acceptably perceivable document that is not intended to be complete (e.g., fully rendered).

With regard to operation 106, referencing of content for at least one of a plurality of portions of a web document may, for example, be deferred, as alluded to above. In some instances, deferring of content may, for example, be based, at least in part, on a determination whether one or more objects are being referenced via a browser, such as discussed above. Thus, in an embodiment, a timeline of referencing of one or more objects representing particular content may, for example, be employed, at least in part. In an embodiment, one or more objects representing content that were referenced, such as via a browser, for example, up to a certain point within an applicable timeline may be rendered, and one or more objects that were referenced after that point may be deferred, just to illustrate one possible implementation. Likewise, in an embodiment, a point within a timeline may be determined, at least in part, experimentally and/or may be pre-defined, for example, depending on a particular embodiment, for example. By way of example, but not limitation, a point corresponding to a time of rendering of acceptably perceivable content may, for example, provide advantages, such as improved timeliness, since it may generally precede full content rendering. Claimed subject matter is, of course, not limited to any particular point in time regarding referencing, including rendering, of content.

In some instances, one or more objects, such as referenced via a browser, for example, may comprise content in connection with an advertisement, as was indicated. In an embodiment, rendering of advertisement-type content may be based, at least in part, on one or more advertising conventions that may, for example, be employed instead of and/or in addition to one or more processes discussed above, such as in connection with operations 102, 104, and/or 106. For example, advertisement-type content may also be referenced, such as via a browser, for example, up to a certain point within an applicable timeline for rendering of a document in a similar fashion, as described previously, for an example embodiment. To illustrate, if a content object for a background image of advertisement-type content is yet to be referenced at a given time, for example, a foreground image, text, etc. may be rendered, such as without waiting for a background image to be referenced, in an example. Claimed subject matter is not so limited, of course. For example, in an embodiment, rendering of an advertisement may, for example, depend at least in part on a variety of potential factors, including a relationship between an advertisement provider, a content provider, publisher, etc., in addition to issues related to loading, executing and/or rendering, as previously discussed, for example. Advertising conventions may also include, for example, one or more pricing methods, transaction mechanisms, contractual relationships, preferences, and/or the like. By way of example, but not limitation, some advertising conventions may include, for example, and/or be based, at least in part, on a cost-per-click (CPC), cost-per-impression (CPM), cost-per-action (CPA) and/or the like. These conventions are generally known and need not be described here in greater detail.

At operation 108, a capability of a suitable computing platform, such as a client device, for example, to selectively render content associated with a plurality of portions of a document may be electronically evaluated. In this context, “selective rendering” of content may refer to a capability as described to reference content objects in a manner so that a level of content that is acceptably perceivable is rendered. In some instances, a set of content may comprise, for example, an otherwise sufficient amount of content (e.g., a number of objects, etc.) that may be referenced for a rendered document to be at least partially operational, such as with functional hyperlinks and/or other functional features, for example. For example, at times, a customization tool may evaluate a suitable state and/or level of rendering of a web document as part of a continuous integration (CI) pipeline or process, just to illustrate one possible implementation.

In an embodiment, a process of rendering of a particular web document may, for example, be monitored, such as during a certain time period (e.g., 6, 12, etc. hours), for example, and applicable instructions (e.g., source code, etc.) may be changed and/or modified so as to result in more effectively and/or more efficiently rendering (e.g., reference fewer objects, etc.). By way of example, but not limitation, software instructions, for example, may be at least partially modified and/or changed, if it is determined, such as using one or more techniques, such as examples discussed above, that certain objects referenced for rendering may be omitted or deferred, for example. As another example, instructions may also be modified and/or changed so as to reference objects that were not previously referenced, such as for rendering of a document, for example.

Likewise, in another embodiment, feedback with respect to aspects, such as speed and/or referencing order of content associated with a web document, for example, may be obtained and used, at least in part, as a basis for improvement. Accordingly, a degradation and/or regression of rendering of a document may, for example, be evaluated and/or flagged and may be correlated to a specific modification and/or change in instructions. If a rendering performance of a web document, measured using user feedback, as an example, falls below a suitable level (e.g., a rendering time has increased, user satisfaction has gone down, etc.), previously changed and/or modified instructions may be restored and/or reverted to a previous version, point in time, and/or the like. It should be noted, although this applies to all the operations, operation 108 may, of course, be optional in certain implementations.

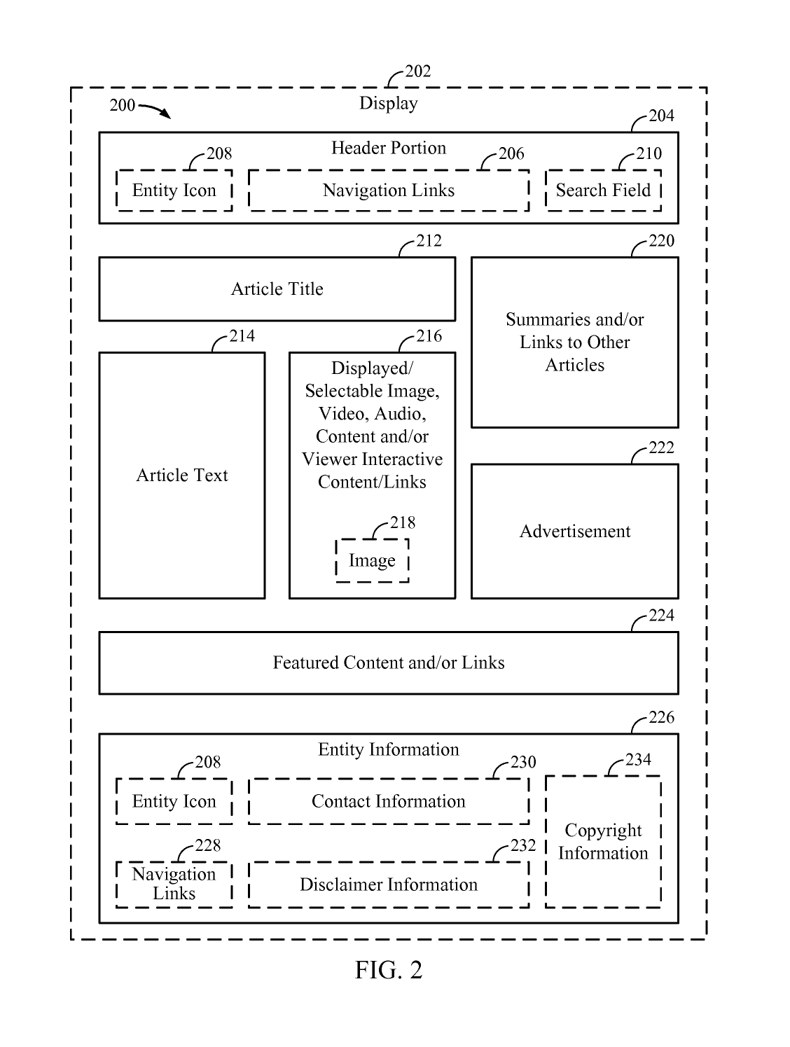

FIG. 2 is an example representation of an implementation of a document 200, such as rendered via display 202 that may, for example, be associated with a device, such as a computing and/or network device. Document 200 may comprise, for example, a rendered web page, such as completely (e.g., fully) rendered in accordance with a designed format, layout, etc. For example, document 200 may comprise a home page, landing page, portal, and/or the like. As also illustrated, document 200 may include, for example, a plurality of portions including various types and/or amounts of on-line content. For example, document 200 may include a header portion 204 with one or more navigation links 206, an entity icon 208, a search field 210, and/or other suitable content. In some instances, an article title portion 212 may, for example, be provided along with an article text portion 214. Another content portion 216 may include, for example, displayed and/or selectable image, video, audio, and/or viewer interactive content and/or links. Content portion 216 may or may not be associated with article text portion 214.

In some instances, an image 218 and/or other like content may be included in document 200, for example, and may be related to article text portion 214. In another content portion 220, summaries and/or links to other possibly related articles may be presented, for example. In an embodiment, a content portion 222 may be provided in which advertisement-type content may, for example, be presented. Another content portion 224 may include, for example, featured content and/or links. As shown in this example, another content portion 226 may provide additional content objects to a viewer (e.g., a user, etc.), such as with regard to document 200, website, entity and/or service provider, such as Yahoo!® (e.g., www.yahoo.com), and/or the like. Here, for example, objects may include entity icon 208, navigation link(s) 228, contact content 230, declaimer content 232, copyright content 234, and/or other content.

As was indicated, in some instances, it may be desirable and/or useful to render document 200 in a manner that may be more timely, such as, for example, by providing an set of content associated with a plurality of document portions for user consumption, interaction, etc. as quickly as feasible and/or suitable, such as by referencing content in a certain order, and/or the like. For example, it may be determined, such as using one or more techniques discussed above, that content relating to an article title (e.g., identified as portion 212), article text (e.g., identified as portion 214), advertisement (e.g., identified as portion 222), header portion 204, viewer interactive content (e.g., identified as portion 216), featured content (e.g., identified as portion 224), entity object 226, disclaimer, copyright, and contact objects 232, 234, and 230, respectively, may be useful and/or desirable to be operational. As such, content relating to remaining portions may, for example, be deferred, such as for rendering at a later point in time (e.g., with a fully rendered content, etc.).

FIG. 3 is a schematic diagram illustrating an example computing environment 300 that may include one or more devices capable of implementing, in whole or in part, one or more processes or operations for more dynamic rendering of on-line content in a document. Computing environment 300 may include, for example, a first device 302 and a second device 304, which may be operatively coupled via a network 306. In an embodiment, first device 302 and second device 304 may be representative of any electronic device, appliance, and/or machine that may have capability to exchange content or like signals over network 306. Network 306 may represent one or more communication links, processes, and/or resources having capability to support exchange and/or communication of content or like signals between first device 302 and second device 304. Second device 304 may include at least one processing unit 308 that may be operatively coupled to a memory 310 through a bus 312. Processing unit 308 may represent one or more circuits to perform at least a portion of one or more applicable computing procedures or processes. For example, although not shown, it should be appreciated that in at least one implementation processing unit 308 or like specialized devices or processors may comprise one or more processing modules capable of electronically obtaining one or more objects representative of content associated with a plurality of portions of a document rendered via a browser; and determining whether the one or more objects are being referenced via the browser while the document is being rendered. It should also be noted that all or part of one or more processing modules may be implemented using or otherwise including hardware, firmware, software, or any combination thereof.

Memory 310 may represent any signal storage mechanism and/or appliance. For example, memory 310 may include a primary memory 314 and a secondary memory 316. Primary memory 314 may include, for example, a random access memory, read only memory, etc. In certain implementations, secondary memory 316 may be operatively receptive of, or otherwise have capability to be coupled to a computer-readable medium 318.

Computer-readable medium 318 may include, for example, any medium that may store and/or provide access to content or like signals, such as, for example, code and/or instructions for one or more devices in operating environment 300. It should be understood that a storage medium may typically, although not necessarily, be non-transitory and/or may comprise a non-transitory device. In this context, a non-transitory storage medium may include, for example, a device that is physical and/or tangible, meaning that the device has a concrete physical form, although the device may change state. For example, one or more electrical binary digital signals representative of content, in whole or in part, in the form of zeros may change a state to represent content, in whole or in part, as binary digital electrical signals in the form of ones, to illustrate one possible implementation. As such, “non-transitory” may refer, for example, to any medium and/or device remaining tangible despite this change in state.

Second device 304 may include, for example, a communication interface 320 that may provide for or otherwise support communicative coupling of second device 304 to network 306. Second device 304 may include, for example, an input/output device 322. Input/output device 322 may represent one or more devices and/or features that may be able to accept or otherwise input human and/or machine instructions, and/or one or more devices and/or features that may be able to deliver or otherwise output human or machine instructions.

According to an implementation, one or more portions of an apparatus, such as second device 304, for example, may store one or more binary digital electronic signals representative of content expressed as a particular state of a device such as, for example, second device 304. For example, an electrical binary digital signal representative of content may be “stored” in a portion of memory 310 by affecting and/or changing a state of particular memory locations, for example, to represent content as binary digital electronic signals in the form of ones and/or zeros. As such, in a particular implementation of an apparatus, such a change of state of a portion of a memory within a device, such a state of particular memory locations, for example, to store a binary digital electronic signal representative of content constitutes a transformation of a physical thing, for example, memory device 310, to a different state or thing.

Thus, as illustrated in various example implementations and/or techniques presented herein, in accordance with certain aspects, a method may be provided for use as part of a special purpose computing device or other like machine that accesses digital signals from memory and/or processes digital signals to establish transformed digital signals which may be stored in memory as part of one or more content files and/or a database specifying or otherwise associated with an index, as discussed above.

Some portions of the detailed description herein are presented in terms of algorithms and/or symbolic representations of operations on binary digital signals stored within a memory of a specific apparatus and/or special purpose computing device and/or platform. In the context of this particular specification, the term specific apparatus or the like includes a general purpose computer once it is programmed to perform particular functions pursuant to instructions from program software. Algorithmic descriptions and/or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and/or similar terms are to be associated with appropriate physical quantities and are intended to merely be convenient labels.

Unless specifically stated otherwise, as apparent from the discussion herein, it is appreciated that throughout this specification discussions utilizing terms such as “processing,” “computing,” “calculating,” “determining” or the like refer to actions and/or processes of a specific apparatus, such as a special purpose computer or a similar special purpose electronic computing device. In the context of this specification, therefore, a special purpose computer or a similar special purpose electronic computing device is capable of manipulating and/or transforming signals, typically represented as physical electronic and/or magnetic quantities within memories, registers, and/or other content storage devices, transmission devices, and/or display devices of the special purpose computer or similar special purpose electronic computing device.

While certain example techniques have been described and/or shown herein using various methods and/or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to particular examples disclosed, but that claimed subject matter may also include all implementations falling within the scope of the appended claims, or equivalents thereof.

What is claimed is:

1. A method comprising:
rendering content of a document in a browser to an at least acceptably perceivable level, said content comprising a plurality of objects.

2. The method of claim 1, wherein said rendering to said at least acceptably perceivable level comprises referencing said plurality of objects in a manner so as to improve timeliness of said rendering.

3. The method of claim 2, wherein said referencing said plurality of objects comprises at least adjusting order of said referencing to at least in part account for dependencies among said plurality of objects.

4. The method of claim 3, wherein said at least adjusting said order of said referencing to at least in part account for said dependencies among said plurality of objects includes at least in part accounting for said order at least with respect to loading, executing, and/or rendering of affected objects of said plurality of objects.

5. The method of claim 3, wherein said at least adjusting said order of said referencing to at least in part account for said dependencies among said plurality of objects includes at least in part determining whether said plurality of objects are being referenced by said browser while said document is being rendered.

6. The method of claim 3, wherein said at least adjusting said order is based, at least in part, on time-stamping.

7. The method of claim 4, wherein said at least adjusting said order includes omitting said loading, executing, and/or rendering of said affected objects of said plurality of objects.

8. The method of claim 4, wherein said at least adjusting said order includes determining one or more adjustments based, at least in part, on a log file showing timing of said loading, executing, and/or rendering of said affected objects of said plurality of objects by said browser.

9. The method of claim 8, wherein said log file is converted to an annotated file regarding said timing of said loading, executing, and/or rendering of said affected objects of said plurality of objects by said browser in the form of a description capable of being readable by a human being.

10. The method of claim 1, wherein said browser is executed on a mobile device.

11. The method of claim 1, wherein one or more of said plurality of objects comprise advertisement content.

12. The method of claim 1, and further comprising deferring referencing of one or more objects of said plurality of objects.

13. A method comprising:
for a set of content objects capable of forming a complete electronic document if said content objects are fully loaded, used, and/or rendered by a browser,
determining, via a computing device, an order of loading, using, and/or rendering of said content objects so as to improve user experience by forming an electronic document before forming said complete electronic document.

14. The method of claim 13, wherein said determining is based, at least in part, on a log file comprising said content objects that have been downloaded via a browser and one or more objects that have been used via said browser.

15. The method of claim 13, wherein said computing device comprises a mobile device.

16. The method of claim 13, wherein said electronic document comprises a useable electronic document rendered at least partially in accordance with a designed format of said electronic document.

17. The method of claim 13, and further comprising:
determining, via said computing device, whether at least one of said one or more content objects comprises content representative of an advertisement; and
rendering said content representative of said advertisement on at least a portion of said electronic document based, at least in part, on one or more advertising rules.

18. The method of claim 13, and further comprising:
determining, via said computing device, a timeline of said order of loading, using, and/or rendering of said content objects; and
deferring rendering of said complete electronic document based, at least in part, on said determined timeline.

19. An apparatus comprising:
a computing platform, said platform including a capability to:
selectively render content of a web page based, at least in part, on one or more content objects loaded for said web page and one or more content objects used for said web page.

20. The apparatus of claim 19, wherein said platform further includes a capability to evaluate said capability of said platform to selectively render said content of said web page.
